(19) United States
(12) Patent Application Publication
(10) Pub. No.: US 2008/0005715 A1
(43) Pub. Date: Jan. 3, 2008

(54) Automatic wiring method of semiconductor integrated circuit, computer program and computer readable storage medium

(75) Inventors: Yoshiaki Shimizu, Tokyo (JP); Kazuhiko Matsuki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ELPIDA MEMORY, INC., Tokyo (JP)

(21) Appl. No.: 11/808,366

(22) Filed: Jun. 8, 2007

(30) Foreign Application Priority Data
Jun. 9, 2006 (JP) 2006-161574

(51) Int. Cl. G06F 17/50

(52) U.S. Cl. 716/13; 716/12; 716/14

(57) ABSTRACT

An automatic wiring method of a semiconductor integrated circuit determines a wiring position based on layout data in which a plurality of cells corresponding to circuit elements of the semiconductor integrated circuit, which comprises the steps of when arranging a predetermined signal line extending in a first direction, extracting one or more coordinates in a second direction orthogonal to the first direction of all connecting terminals selected to be connected to the predetermined signal line among connecting terminals respectively included in the plurality of cells; calculating an average value of the extracted coordinates; and determining a position of the predetermined signal line in the second direction based on the average value.

### BACKGROUND OF THE INVENTION

1. Field of the Invention

The present invention relates to a layout system for layout design of a semiconductor integrated circuit, and particularly relates to an automatic wiring method for determining an optimum position of a line connected to one or more ports (connecting terminals) of cells included in the semiconductor integrated circuit.

2. Description of the related art

Conventionally, when connecting a signal line to a large number of cells serving as circuit elements in layout design of a semiconductor integrated circuit, an automatic wiring method for automatically determining the position of the signal line is well-known (refer to, e.g., Japanese Patent Application Publication No. 2000-200834 and Japanese Patent Application Publication No. 6-310600). Such an automatic wiring method of the semiconductor integrated circuit is performed, for example in processing shown in a flowchart of FIG. 7. In the processing shown in FIG. 7, layout data in which a plurality of cells included in the semiconductor integrated circuit have been arranged is obtained (Step S1). Then, the plurality of cells each having a port (connecting terminal) to be connected to a predetermined signal line is specified in the layout data, and data related to the ports as connection targets attached to the respective cells is extracted (Step S2). Here, if it is assumed that the predetermined signal line extends in X direction, the data extracted in step S2 includes coordinates in Y direction of the ports as the connection targets. Subsequently, the maximum value and the minimum value among the Y coordinates of the ports as the connection targets are determined, and the central position between both the values is obtained (Step S3). As a consequence, the central position obtained in step S3 is set as the Y coordinate of the signal line so that the optimum wiring position is determined (Step S4). By arranging the signal line at the determined position, each port as the connection target is connected to the signal line by a lead-in line extending in the Y direction.

However, the recent improvement in integration of the semiconductor integrated circuit requires low voltage and high-speed operation, thereby increasing the influence of the arrangement of the signal line. Further, the layout in which a large number of ports are connected to the signal line particularly has a problem of an increase in resistance and capacitance of a large number of the lead-in lines for connecting the ports to the signal line. In this case, according to the conventional automatic wiring method, even if the number of ports is large, the central position between the maximum and minimum values of the coordinates is set as the position of the signal line. Therefore, even if the distribution of the coordinates of the ports is deviated, this is not considered and the optimum arrangement for reducing the resistance and capacitance cannot be realized.

### BRIEF SUMMARY OF THE INVENTION

It is an object of the present invention to provide an automatic wiring method of a semiconductor integrated circuit, in which when arranging a signal line of the semiconductor integrated circuit, even if a large number of ports having a complicated distribution are connected to the signal line, the optimum arrangement for the signal line can be determined so as to suppress the influence of resistance and capacitance of lead-in lines.

An aspect of the present invention is an automatic wiring method of a semiconductor integrated circuit for determining a wiring position based on layout data in which a plurality of cells corresponding to circuit elements of the semiconductor integrated circuit is arranged, the automatic wiring method comprising the steps of: when arranging a predetermined signal line extending in a first direction, extracting one or more coordinates in a second direction orthogonal to the first direction of all connecting terminals selected to be connected to said predetermined signal line among connecting terminals respectively included in said plurality of cells; calculating an average value of the extracted coordinates; and determining a position of said predetermined signal line in the second direction based on said average value.

According to the automatic wiring method of the present invention, when arranging the predetermined signal line extending in the first direction based on the layout data, the connecting terminals to be connected are selected from the layout data, the average value of the extracted coordinates of the connecting terminals in the second direction is calculated, and the position of the signal line can thus be determined. Therefore, even if a large number of the connecting terminals connected to the signal line have a complicated distribution, the signal line can be arranged at the optimum position. Accordingly, the influence of capacitance and resistance of the lead-in lines for connecting the connecting terminals to the signal line is suppressed, and excellent signal transmission characteristics can be obtained.

Another aspect of the present invention is an automatic wiring method of a semiconductor integrated circuit for determining a wiring position based on layout data in which a plurality of cells corresponding to circuit elements of the semiconductor integrated circuit is arranged, the automatic wiring method comprising the steps of: when arranging a predetermined signal line extending in a first direction, extracting one or more coordinates in a second direction orthogonal to the first direction of all connecting terminals selected to be connected to said predetermined signal line among connecting terminals respectively included in said plurality of cells; when a weighting of each connecting terminal is designated, calculating an average value of the extracted coordinates on the basis of said weighting; and determining a position of said predetermined signal line in the second direction based on said average value.

According to the present invention, in addition to the above described function and effect, the weighting of each connecting terminal is designated, which is reflected in the calculation of the average value. Therefore, the signal line can be arranged to be close to the connecting terminals with high importance in view of signal transmission characteristics, and thereby further improving the signal transmission characteristics.

In the present invention, a scale factor for calculating said average value corresponding to the designation of said weighting may be set, and the average value may be calculated by assuming that there are the connecting terminals to be connected the number of which corresponds to said scale factor thereof.

In the present invention, said scale factor corresponding to the designation of said weighting may be set based on a transistor size of the cell having the connecting terminal to be connected.

In the present invention, each connecting terminal to be connected may be connected to said predetermined signal line by a lead-in line extending in the second direction.

An aspect of the present invention is a computer program for executing the above-mentioned automatic wiring method of the semiconductor integrated circuit. Further, an aspect of the present invention is a computer readable storage medium storing the above-mentioned computer program

As described above, according to the present invention, when arranging the predetermined signal line in the semiconductor integrated circuit, for example, by calculating the average value of the coordinates based on the coordinates of the connecting terminals selected to be connected, or by considering the weighting of each connecting terminal, the position of the signal line is determined. Accordingly, even when a large number of ports having a complicated distribution are connected to the signal line, the influence of the capacitance and resistance of the lead-in lines for connecting the connecting terminals to the signal line can be minimized and the layout in which the signal line is arranged at the optimum position capable of obtaining excellent signal transmission characteristics can be realized.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a flowchart for explaining a processing to which an automatic wiring method of an embodiment is applied;

FIG. 2 is a diagram showing an arrangement example of layout data of step S11 of FIG. 1;

FIG. 3 is a diagram showing a first data table as a data example extracted in step S12 of FIG. 1;

FIG. 4 is a diagram showing a layout in which a signal line S is arranged at a position where the Y coordinate is to be an average value YA1 corresponding to the layout of FIG. 2;

FIG. 5 is a diagram showing a second data table as a data example extracted in step S12 of FIG. 1;

FIG. 6 is a diagram showing a layout in which a signal line S is arranged at a position where the Y coordinate is to be an average value YA2 corresponding to the layout of FIG. 2; and

FIG. 7 is a flowchart for explaining a processing to which a conventional automatic wiring method is applied.

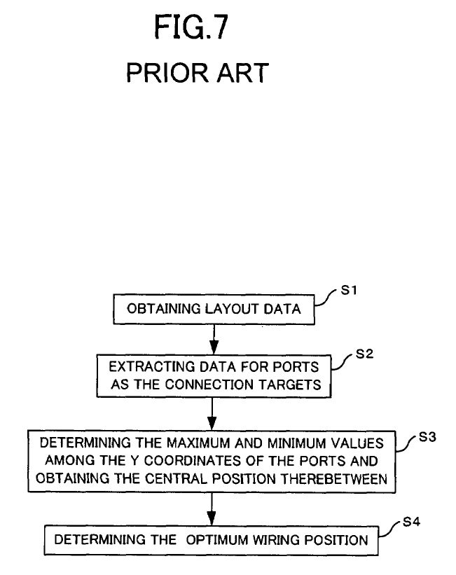

### DETAILED DESCRIPTION OF THE INVENTION

A preferred embodiment of the present invention will be described below with reference to accompanying drawings. In the embodiment, it is necessary to configure a layout system using a personal computer or the like so as to execute a computer program of an automatic wiring method of a semiconductor integrated circuit according to the present invention. With such a layout system, a specific description will be given of a case in which a storage medium for storing the computer program of the automatic wiring method of the present invention is read and executed.

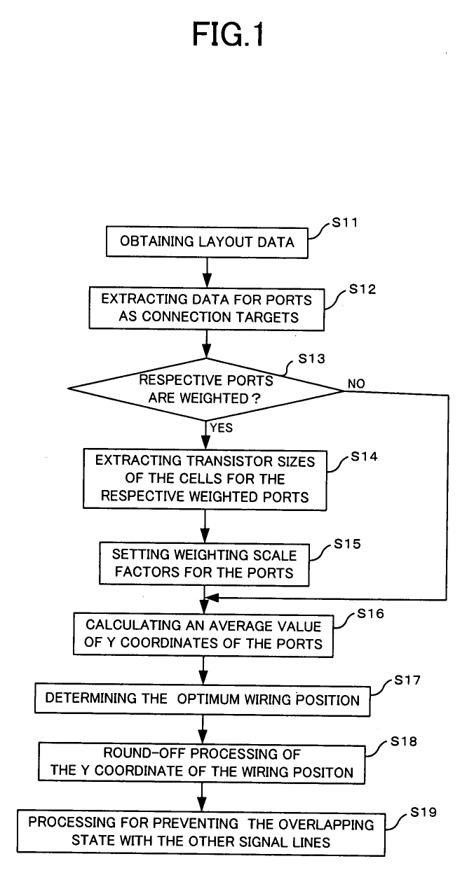

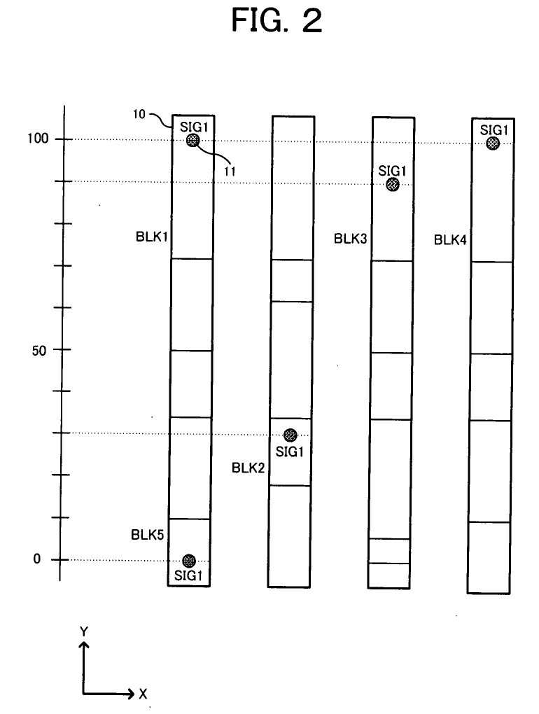

FIG. 1 is a flowchart for explaining a processing to which the automatic wiring method of the embodiment is applied. Starting the processing of the embodiment, layout data in which cells corresponding to circuit elements in the semiconductor integrated circuit have been arranged is obtained (Step S11). Herein, an arrangement example of the layout data of step S11 is shown in FIG. 2. Referring to FIG. 2, a layout constructed in a predetermined planar region in which coordinates are specified by X (lateral direction in FIG. 2) and Y (longitudinal direction in FIG. 2) is shown, and the layout includes a large-number of rectangular cells 10 and ports 11 arranged in the cells 10. The cells 10 correspond to elements such as transistors formed on the semiconductor substrate. Further, the ports 11 correspond to connecting terminals of a predetermined signal which is input to or output from the cells 10.

In the example of FIG. 2, a large number of cells 10 having various sizes are arranged in four lines. Among the cells, the ports 11 expressed as a port name SIG1 are arranged in five cells 10 expressed as cell names BLK1, BLK2, BLK3, BLK4, and BLK5. Since the port name of each port 11 corresponds to a signal, the ports 11 having the same port name are commonly connected to a predetermined signal line. Although, only the port 11 having the port name SIG1 is shown for the purpose of a brief description, a large number of ports 11 having different port names corresponding to a plurality of signals may be arranged.

Next, in the layout data obtained in step S11, cells 10 each including the port 11 to be connected to the signal line is specified, and data for the ports 11 as the connection targets attached to the cells 10 is extracted (Step S12). In the embodiment, the optimum Y coordinate of the signal line is intended to be determined when connecting predetermined ports 11 to the signal line extending in the X direction. For example, in FIG. 2, in a case in which the signal line connected to the five ports 11 having the port name SIG1 is arranged, the optimum value is determined from a range of the Y coordinates relatively indicated at the left end in FIG. 2 by calculation based on data such as the coordinates of the ports 11, which will be described later. Therefore, in step S12, data necessary for later-described processing such as cell names of the cells 11 each including the port 11 as the connection target and the coordinates of the port 11 as the connection target, is extracted.

Subsequently, among the data extracted in step S12, it is determined whether or not respective ports 11 are weighted (Step S13), and processing in accordance with the determination result is performed. As a consequence, when it is determined that the ports 11 are not weighted (Step S13: NO), the processing shifts to step S16 without executing steps S14 and S15 (first case). On the other hand, when it is determined that the one or more ports 11 are weighted (Step S13: YES), the processing shifts to step S14 (second case).

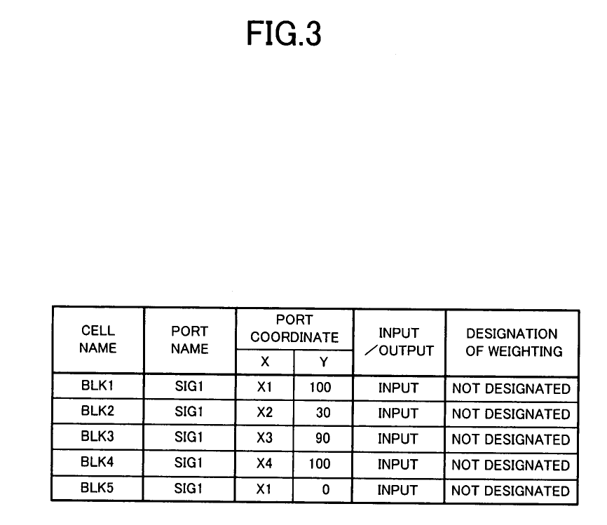

First, the first case in which the processing is shifted to step S16 without weighting the port 11 will be described. FIG. 3 shows a first data table as a data example extracted in step S12 and a case in which the same transistor size (gate width) is set for each cell 10 is shown. The first data table shown in FIG. 3 includes cell names of cells 10 as calculation targets, port names of ports 11 attached to the cells 10, port coordinates, discriminations whether the ports 11 are for input or output, and whether or not respective ports 11 are weighted. The cell names and the port name are identical to those of the layout of FIG. 2. Although the X coordinates of the port coordinates are not used for the calculation described later, they are expressed as X1, X2, X3, and X4 corresponding to the positions of rows of the cells 10 for the purpose of convenience. Further, the Y coordinates of the port coordinates correspond to values indicated at the left end in FIG. 2. In the example of FIG. 3, all the ports 11 are input ports and the cells 10 corresponding thereto have the same transistor size, and thus weightings are not designated.

It is possible to selectively define whether or not the weightings of the ports 11 are designated in the layout system. That is, a user of the layout system can select that the ports 11 are not weighted for the signal line of low importance. Further, the weightings of the ports 11 maybe defined for output ports connected to the signal line, while the weightings of the ports 11 as input ports may not be designated. Further, when designating the weightings in accordance with the transistor size, the weightings of the cells 10 having the same transistor size of the cells 10 can be the same, and consequently the respective ports 11 can have the same weighting.

Next, an average value of the Y coordinates of the respective ports 11 is calculated (Step S16). In the example of the first data table of FIG. 3, the number of ports is five and therefore an average value YA1 is obtained by the following calculation expression with the Y coordinate values of the ports 11.

YA1=(100+30+90+100+0)/5=64

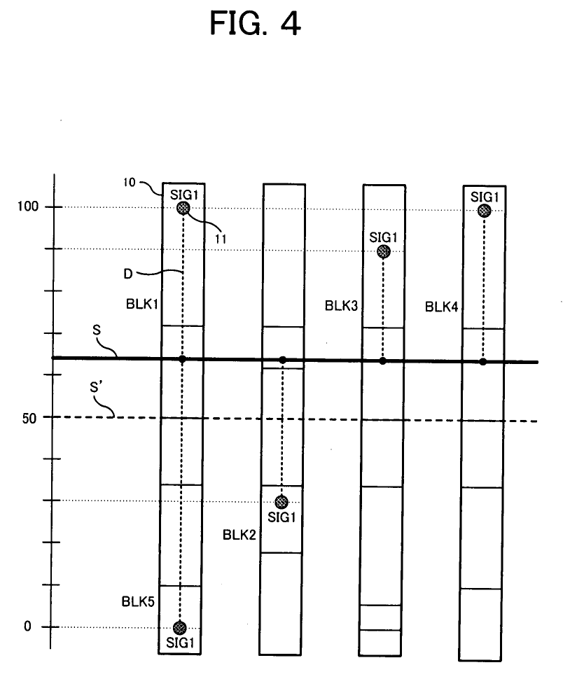

Subsequently, the optimum wiring position is determined on the basis of the calculation result in step S16 (Step S17). Specifically, the average value YA1 calculated in step S16 is set as the Y coordinate of the signal line extending in the X direction. Herein, FIG. 4 shows a layout in which a signal line S is arranged at a position where the Y coordinate is to be the average value YA1 corresponding to the layout of FIG. 2. In FIG. 4, it is understood that the signal line S extending in the X direction is arranged at the position of Y=64. Meanwhile, for the comparison with the embodiment, a signal line S′ arranged at a position obtained with the conventional method is also shown. According to the conventional method, among the Y coordinates of the five ports 11, the Y coordinate is determined to be 50, which is an average value of a maximum value 100 and a minimum value 0.

In FIG. 4, in order to connect the ports 11 to the signal line S, a plurality of lead-in lines D extending in the Y direction is shown by dotted lines. These lead-in lines D are laid out by a sequential processing after obtaining the result of step S17. In this case, with respect to a total line length L of five lead-in lines D to the five ports 11, since the distances from the Y coordinates of the ports 11 to the signal line S are respectively 36, 34, 26, 36, and 64, it can be calculated as follows.

L=36+34+26+36+64=196

### On the other hand, with the conventional method, since the distances from the Y coordinates of the ports 11 to the signal line S′ are respectively 50, 20, 40, 50, and 50, a total line length L′ can be calculated as follows.

L′=50+20+40+50+50=210

As mentioned above, in the first case of the embodiment, as compared with the conventional method, the line length necessary for connecting the ports 11 which are distributed variously to the signal line S can be averagely reduced. Referring to FIG. 4, obviously, the signal line S determined by the method of the embodiment is shifted in an increasing direction of Y, compared with the arrangement determined by the conventional method. That is, there are two ports 11 on the side of smaller Y, while there are three ports 11 on the side of larger Y. Therefore, a signal line S is arranged to be relatively close to the side where many ports 11 are distributed.

In FIG. 4, the signal line S extending in the X direction serves as a trunk line and the lead-in lines D extending in the Y direction for connecting the ports 11 to the signal line S serve as branch lines. In general, the trunk line among the signal lines for transmitting a predetermined signal is connected to many ports 11 via many branch lines. Therefore, it is important to determine an optimum position of the trunk line to ensure signal transmission characteristics. By determining the optimum position of the signal line S as the trunk line with the method of the embodiment, the influence of the capacitance and resistance of the lead-in lines D as the branch lines is suppressed and the signal transmission characteristics are improved.

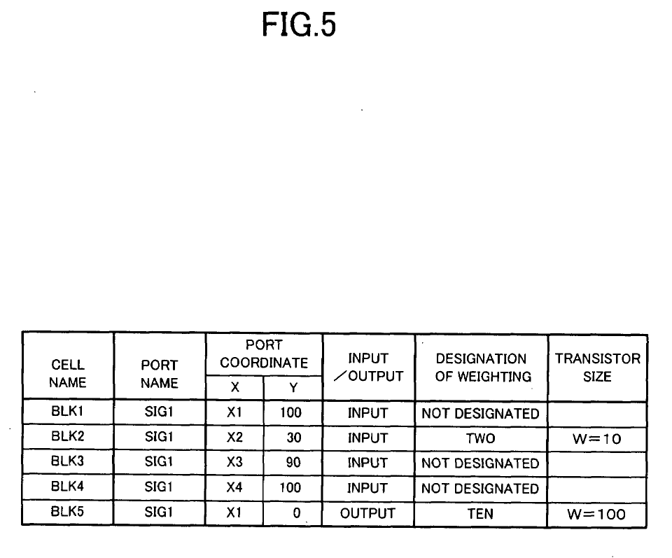

Next, the second case in which the processing is shifted to step S14 after the weightings of the ports 11 are designated will be described. FIG. 5 shows a second data table as a data example extracted in step S12 and a case in which different transistor sizes are set for each cell 10 and the weightings are designated for each cell in accordance with the transistor sizes. The second data table shown in FIG. 5 includes the same items regarding the cell name of each cell 10 serving as a calculation target, the port name of each port 11 attached to the cell 10, the port coordinate, and the discrimination whether each port 11 is for input or output.

Meanwhile, as shown in the second data table, the weightings are designated for the ports 11, and the transistor sizes of the corresponding cells 10 are extracted for the respective weighted ports 11 (Step S14). In the example of FIG. 5, three ports 11 among five ports 11 are not weighted similarly to that shown in FIG. 3. However, the remaining two ports 11 are weighted. In this case, the transistor size W=10 is set for the cell 10 having the cell name BLK2, and the transistor size W=100 is set for the cell 10 having the cell name BLK5. Here, only the port 11 attached to the cell 10 having the cell name BLK5 is an output port.

Further, as shown in the second data table, weighting scale factors corresponding to the transistor sizes extracted in step S14 is set for the ports 11 for which the weightings are determined (Step S15). In the example of FIG. 5, the weighting scale factor (w) for the port 11 attached to the cell 10 having the cell name BLK2 is two, and the weighting scale factor (w) of the port 11 attached to the cell 10 having the cell name BLK5 is ten. Although each weighting scale factor of the port 11 increases or decreases depending on the transistor size, the weighting scale factors of the ports 11 are not limited to the relationship shown in FIG. 5 and can be properly set in accordance with desired characteristics.

Next, an average value of the Y coordinates of the respective ports 11 is calculated on the basis of the setting of step S15 (Step S16). Specifically, it is assumed that there are the ports 11 the number of which corresponds to its weighting scale factor. In the second data table, although the original number of ports 11 is 5, it is assumed that there are two ports 11 attached to the cell 10 having the cell name BLK2 and there are ten ports 11 attached to the cell 10 having the cell name BLK5. As a consequence, the average value YA2 of the Y coordinates of the ports 11 can be obtained by the following calculation expression.

YA2=(100+30×2+90+100+0×10)/(3+2+10)=23.4

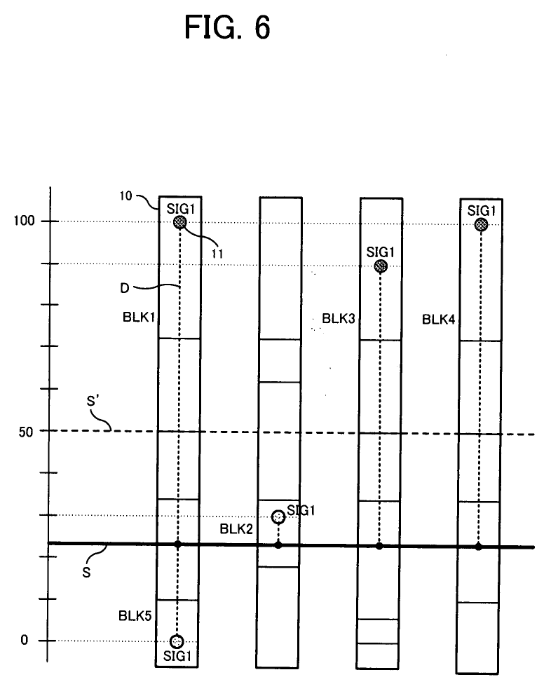

As mentioned above, in the second case of the embodiment, by weighting the ports 11 respectively, the signal line S is set to be close to the side of the port 11 attached to the cell 10 having a large transistor size. In FIG. 6, by comparing the lead-in lines D (shown by dotted lines) for connecting the ports 11 to the signal line S, it is understood that the line lengths of two ports 11 for which the weightings are designated are shorter than those of the remaining ports 11. Thus, a layout capable of reducing the influence of the capacitance and resistance can be realized with respect to the port 11 of the cell 10 having a large transistor size.

Next, the optimum wiring position is determined based on the calculation result of step S16 (Step S17). Similarly to the first case using the average value YA1, the average value YA2 calculated in step S16 is set as the Y coordinate of the signal line extending in the X direction. Herein, FIG. 6 shows a layout in which the signal line S is arranged at a position where the Y coordinate is the average value YA2 corresponding to the layout shown in FIG. 2. In FIG. 6, it is understood that the signal line S extending in the X direction is arranged at a position of Y=23.4. Similarly to FIG. 4, the signal line S′ based on the conventional method is arranged at a position of Y=50. However, on the contrary to FIG. 4, the signal line S based on the average value YA2 is shifted in a reducing direction of Y.

In the second case, the description is given where the weighting scale factor is set corresponding to the transistor size of the cell 10. However, weighting information used for setting the weighting can be freely selected as well as the transistor size. For example, gate capacitance or ON-resistance of the transistor may be set as the weighting information. Incidentally, the gate capacitance or the ON-resistance of the transistor can be calculated from the gate width and the gate length of the transistor. Further, the gate capacitance can be calculated with high precision in consideration of a thickness of a gate oxide film of the transistor. Further, the capacitance value and the resistance value of each lead-in line D which is obtained from the gate capacitance and the ON-resistance of the transistor may be set as the weighting information. Incidentally, the weighting information can be designated by directly selecting a predetermined cell name and a predetermined signal name without using a parameter of the transistor.

Next, a description will be given of auxiliary processing for the wiring position determined in step S17. First, round-off processing of the Y coordinate of the wiring position determined in step S17 is performed (Step S18). That is, when a large number of the signal lines including the above-mentioned signal line S are arranged in the entire layout of the semiconductor integrated circuit, a predetermined wiring pitch is determined as a positional relationship between the signal lines. Thus, the round-off processing of the wiring position determined in step S17 is required to ensure the predetermined wiring pitch between the signal lines. For example, if this round-off processing is applied to Y=23.4 obtained in step S17, the resultant value is then slightly corrected in an increasing direction or in a decreasing direction.

Next, it is determined whether or not the signal line S based on the round-off processing in step S18 is overlapped at the same position as the other signal line, and processing for preventing the overlapping state is performed (Step S19). When there are a large number of signal lines extending in the X direction, the wiring positions thereof can be possibly overlapped at the same position as the result of step S17. However, in such a case, the overlapping state needs to be prevented in consideration of priorities of the signal lines. For example, in the above-mentioned second case, a total value of the weighting scale factors of the ports 11 to be connected is obtained for each of signal lines which are overlapped with each other, and by comparing the obtained values, the priorities of signal lines can be determined. By this, when the total value of the weighting scale factors is larger than the other, the optimum wiring position is maintained. On the other hand, when the total value of the weighting scale factors is smaller than the other, the wiring position is moved in accordance with the wiring pitch. Such a determination of priorities is repeated until the overlapping state of the signal lines is prevented.

As described above, the present invention is described according to the embodiment. However, the present invention is not limited to the embodiment and can variously be modified without departing the essentials of the present invention. For example, in the embodiment, the description is given of the case of determining the optimum position of the signal line extending in the X direction. However, the present invention can be widely applied to, e.g., the case of determining the optimum position of the signal line extending in an arbitrary direction in a layout as well as the X direction.

The present invention is not limited to the above described embodiments, and various variations and modifications may be possible without departing from the scope of the present invention.

This application is based on the Japanese Patent application No. 2006-161574 filed on Jun. 9, 2006, entire content of which is expressly incorporated by reference herein.

What is claimed is:

1. An automatic wiring method of a semiconductor integrated circuit for determining a wiring position based on layout data in which a plurality of cells corresponding to circuit elements of the semiconductor integrated circuit is arranged, the automatic wiring method comprising the steps of:
when arranging a predetermined signal line extending in a first direction, extracting one or more coordinates in a second direction orthogonal to the first direction of all connecting terminals selected to be connected to said predetermined signal line among connecting terminals respectively included in said plurality of cells;
calculating an average value of the extracted coordinates; and
determining a position of said predetermined signal line in the second direction based on said average value.

2. An automatic wiring method of a semiconductor integrated circuit for determining a wiring position based on layout data in which a plurality of cells corresponding to circuit elements of the semiconductor integrated circuit is arranged, the automatic wiring method comprising the steps of:
when arranging a predetermined signal line extending in a first direction, extracting one or more coordinates in a second direction orthogonal to the first direction of all connecting terminals selected to be connected to said predetermined signal line among connecting terminals respectively included in said plurality of cells;
when a weighting of each connecting terminal is designated, calculating an average value of the extracted coordinates on the basis of said weighting; and
determining a position of said predetermined signal line in the second direction based on said average value.

3. An automatic wiring method of the semiconductor integrated circuit according to claim 2, wherein a scale factor for calculating said average value corresponding to the designation of said weighting is set, and the average value is calculated by assuming that there are the connecting terminals to be connected the number of which corresponds to said scale factor thereof.

4. An automatic wiring method of the semiconductor integrated circuit according to claim 3, wherein said scale factor corresponding to the designation of said weighting is set based on a transistor size of the cell having the connecting terminal to be connected.

5. An automatic wiring method of the semiconductor integrated circuit according to claim 1, wherein each connecting terminal to be connected is connected to said predetermined signal line by a lead-in line extending in the second direction.

6. An automatic wiring method of the semiconductor integrated circuit according to claim 2, wherein each connecting terminal to be connected is connected to said predetermined signal line by a lead-in line extending in the second direction.

7. A computer program for executing the automatic wiring method of the semiconductor integrated circuit according to claim 1.

8. A computer program for executing the automatic wiring method of the semiconductor integrated circuit according to claim 2.

9. A computer readable storage medium storing the computer program according to claim 7.

10. A computer readable storage medium storing the computer program according to claim 8.
